(19) United States
(12) Patent Application Publication
(10) Pub. No.: US 2024/0398170 A1
(43) Pub. Date: Dec. 5, 2024

(54) MULTIFUNCTIONAL DRIVING MECHANISM, AND ELECTRICAL APPLIANCE FOR KITCHEN

(71) Applicant: SANLIDA ELECTRICAL TECHNOLOGY CO.,LTD, Shenzhen (CN)

(72) Inventor: Chuang LI, Shenzhen (CN)

(73) Assignee: SANLIDA ELECTRICAL TECHNOLOGY CO.,LTD, Shenzhen (CN)

(21) Appl. No.: 18/450,354

(22) Filed: Aug. 15, 2023

(30) Foreign Application Priority Data
May 29, 2023 (CN) 202321325104.0

(51) Int. Cl. A47J 43/08; A47J 43/044; A47J 44/00

(52) U.S. Cl. CPC A47J 43/087; A47J 43/044; A47J 43/082; A47J 44/00; A47J 2043/04454

(57) ABSTRACT

The present invention relates to the technical field of electrical appliances for kitchen. The multifunctional driving mechanism uses a first output shaft and a second output shaft. A stirring assembly is detachably connected to a bottom of the first output shaft for mixing dough, whipping butter and eggs, and the like. The other end of the second output shaft is provided with a splicing slot in abutting joint to an accessory driving shaft, and an accessory joint can be added to make noodles, mince meat, stuff sausages, slice, shred, dice, grind, juice, and the like, with various functions and convenience in use; moreover, the first output shaft is perpendicular to the second output shaft, and the first output shaft and the second output shaft neither conflict with each other nor occupy a very large space during simultaneous working, so that the structure is compact.

### CROSS-REFERENCE TO RELATED APPLICATIONS

The application claims priority to Chinese patent application No. 202321325104.0, filed on May 29, 2023, the entire contents of which are incorporated herein by reference.

### TECHNICAL FIELD

The present invention relates to the technical field of electrical appliances for kitchen, and particularly relates to a multifunctional driving mechanism and an electrical appliance for kitchen.

### BACKGROUND

A dough mixer is a common electrical appliance for kitchen. Besides mixing dough, it is often used for whipping butter and egg liquids. An existing driving mechanism of the dough mixer includes a driving shaft, a gear plate arranged on an outer side of the driving shaft in a penetrating manner, a turnplate assembly fixed at a bottom of the driving shaft, and an output shaft arranged in the turnplate assembly in a penetrating manner, wherein a gear is fixed at a top of the output shaft, and the gear is meshed with an inner side of the gear plate. During use, the driving shaft drives the turnplate assembly to rotate, the output shaft arranged on the turnplate assembly does an eccentric motion around the driving shaft, a bottom of the output shaft can be assembled with accessories such as a dough mixing hook and an egg beating cage, and the gear is meshed with the gear plate to ensure the operating stability.

However, an existing dough mixer only has one output shaft. Except for mixing dough, and whipping butter and eggs, the dough mixer features single function.

### SUMMARY

To overcome shortcomings and deficiencies in the prior art, an objective of the present invention is to provide a multifunctional driving mechanism and an electrical appliance for kitchen.

The objective of the present invention is achieved by the following technical solution: a multifunctional driving mechanism, including a first output shaft, a first driving mechanism configured to drive the first output shaft to rotate, a second output shaft perpendicular to the first output shaft, and a second driving mechanism configured to drive the second output shaft to rotate;
wherein the first driving mechanism includes a motor, a driving wheel fixed at an output end of the motor, a driven wheel arranged on one side of the driving wheel, a driving belt connected between the driving wheel and the driven wheel, a first helical gear coaxially fixed below the driven wheel, a second helical gear meshed with the first helical gear, a driving gear coaxially fixed at a bottom of the second helical gear, an output gear meshed with the driving gear, a rotating shaft fixed in a middle portion of the output gear, and a rotating piece fixed at a bottom of the rotating shaft, a middle portion of the first output shaft is rotatably connected to the other end of the rotating piece, and a stirring assembly is detachably connected to a bottom of the first output shaft;
the first driving mechanism further includes a gear ring fixed on an outer side of the rotating shaft and a planetary gear fixed at a top of the first output shaft, the planetary gear being meshed with an inner side of the gear ring; and
the second driving mechanism includes a first bevel gear fixed in an upper portion of the rotating shaft and a second bevel gear meshed with the first bevel gear, wherein one end of the second output shaft is fixed in a middle portion of the second bevel gear, a connecting portion is fixed at the other end of the second output shaft, and the other end of the connecting portion is provided with a splicing slot in abutting joint to an accessory driving shaft.

The stirring assembly includes a stirring hook, a stirring racket or an egg beating cage.

The accessory includes a noodle roller, a noodle cutter, a meat mincer, a sausage stuffer, a fruit and vegetable peeling machine, a shredding and slicing machine, a food shredder, a grain grinder, a juicer or a slow juicer.

The multifunctional driving mechanism further includes a mounting panel and a gear seat fixed on one side of a bottom of the mounting panel, wherein the motor is fixed on the other side below the mounting panel, the output end of the motor passes through the mounting panel upwards and rotates synchronously along with the driving wheel, a top of the gear seat is provided with an accommodation groove for accommodating the first helical gear, the second helical gear, the driving gear, the output gear, and the first bevel gear, a bottom of a central shaft of the first helical gear is rotatably connected to a bottom of the accommodation groove, a top of the central shaft of the first helical gear passes through the mounting panel upwards and rotates synchronously along with the driven wheel, and central shafts of the second helical gear and the driving gear are rotatably connected between the bottom of the mounting panel and the bottom of the accommodation groove; a middle portion of the rotating shaft is rotatably connected to a bottom of the gear seat, the bottom of the rotating shaft passes through the bottom of the gear seat downwards and stretches out, the gear ring is fixed at the bottom of the gear seat, a top of the rotating shaft passes through the mounting panel upwards and stretches out, a position, corresponding to the first bevel gear, of the mounting panel is provided with a through hole, and a lower portion of the second bevel gear passes through the through hole and is meshed with the first bevel gear.

A protective cover is connected to an outer side of the rotating piece in a sleeved manner.

A mounting shell is fixed on one side of a top of the mounting panel, a position, corresponding to the connecting portion, of the mounting shell is provided with an assembly hole, and a mounting portion for mounting an accessory is fixed on an outer side of the assembly hole.

A plurality of L-shaped clamping blocks are arranged in a ring array on an outer side of the mounting portion.

The mounting shell is provided with a locking mechanism for locking the accessory.

The locking mechanism includes a locking bar slidably connected on an outer side of the mounting shell, a pulling bar fixed on one side of the locking bar, and a compression spring abutted between the mounting shell and the pulling bar.

An electrical appliance for kitchen, including the above-mentioned multifunctional driving mechanism.

The present invention has the following beneficial effects: the multifunctional driving mechanism uses a first output shaft and a second output shaft. A stirring assembly is detachably connected to a bottom of the first output shaft for mixing dough, whipping butter and eggs, and the like. The other end of the second output shaft is provided with a splicing slot in abutting joint to an accessory driving shaft, and an accessory joint can be added to make noodles, mince meat, stuff sausages, slice, shred, dice, grind, juice, and the like, with various functions and convenience in use; moreover, the first output shaft is perpendicular to the second output shaft, and the first output shaft and the second output shaft neither conflict with each other nor occupy a very large space during simultaneous working, so that the structure is compact. A first driving mechanism and a second driving mechanism share one motor, so that the cost can be lowered and the product size can be reduced while the driving efficiency can be guaranteed.

The electrical appliance for kitchen provided by the present invention can not only be used for mixing dough, whipping butter and eggs, and the like, but also be added with accessory joints for making noodles, mincing meat, stuffing sausages, slicing, shredding, dicing, grinding, juicing, and the like, with various functions and convenience in use.

### BRIEF DESCRIPTION OF DRAWINGS

FIG. 1 is a three-dimensional diagram of the present invention.

FIG. 2 is a three-dimensional diagram of the present invention without the mounting panel, the gear seat, the mounting shell and the protective cover.

FIG. 3 is a three-dimensional diagram of the mounting panel, the gear seat, the mounting shell and the protective cover of the present invention.

FIG. 4 is a three-dimensional exploded view of the mounting panel, the gear seat, the mounting shell and the protective cover of the present invention.

FIG. 5 is a three-dimensional diagram of the electrical appliance for kitchen of the present invention when it is a dough mixer.

Numerals in the drawings: 1—first output shaft; 2—second output shaft; 30—motor; 31—driving wheel; 32—driven wheel; 33—driving belt; 34—first helical gear; 35—second helical gear; 36—driving gear; 37—output gear; 38—rotating shaft; 39—rotating piece; 40—stirring assembly; 41—gear ring; 42—planetary gear; 51—first bevel gear; 52—second bevel gear; 53—connecting portion; 531—splicing slot; 6—mounting panel; 61—through hole; 7—gear seat; 71—accommodation groove; 8—protective cover; 9—mounting shell; 91—assembly hole; 92—mounting portion; 93—L-shaped clamping block; 94—locking mechanism; 941—locking bar; 942—pulling bar; 943—compression spring; 101—base; 102—head; 103—stirring bucket; 104—base plate; 105—support; 106—side cover.

### DETAILED DESCRIPTION OF THE EMBODIMENTS

In order to facilitate understanding of those skilled in the art, the present invention will be further described below in combination with embodiments and drawings 1-5. The contents mentioned in the embodiments do not limit the present invention.

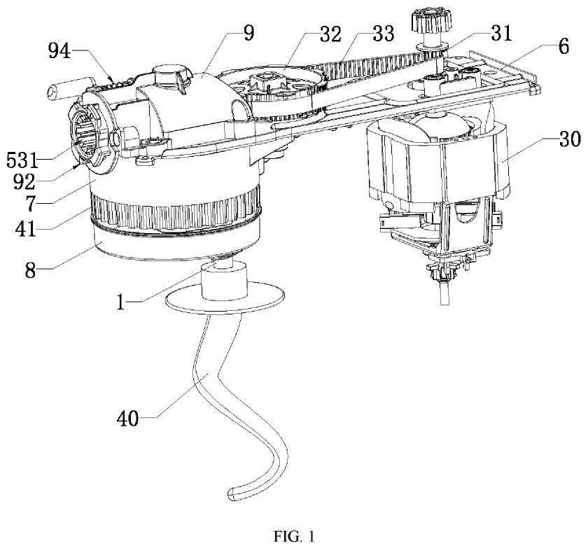

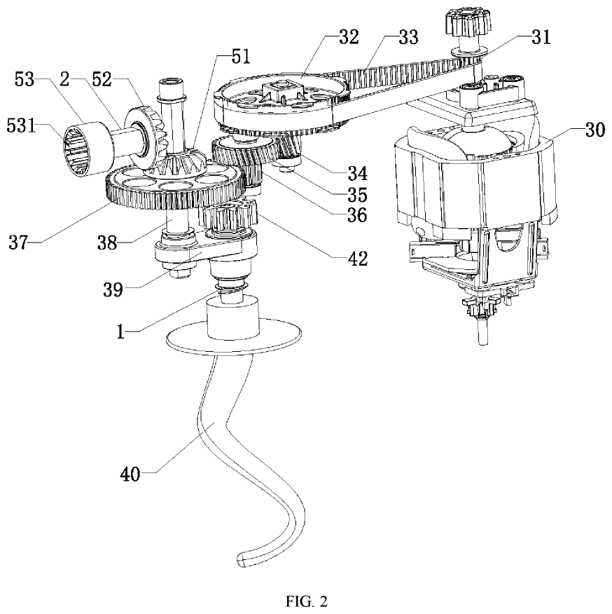

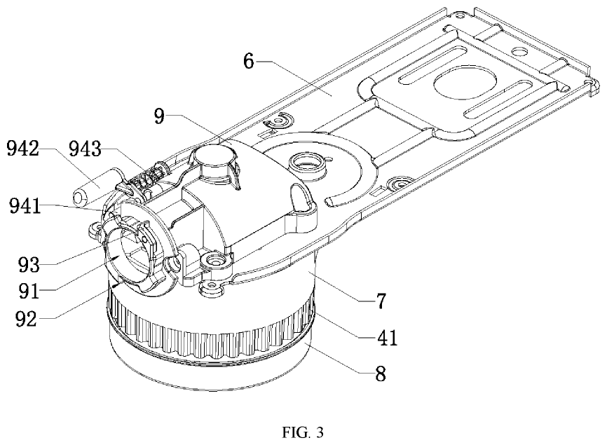

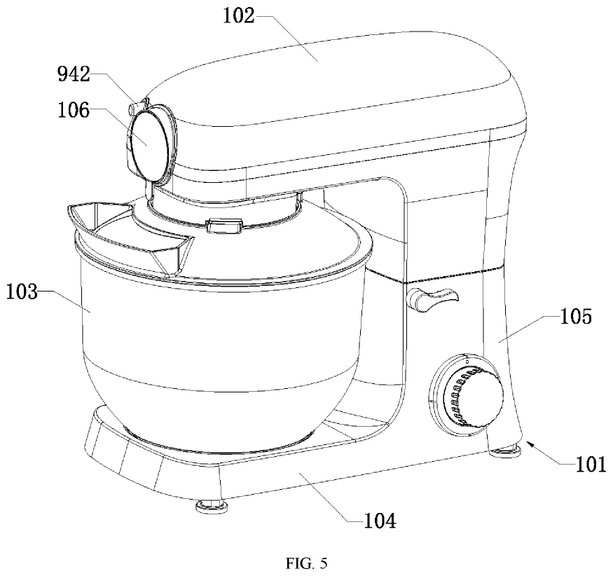

As shown in FIGS. 1-5, a multifunctional driving mechanism includes a first output shaft 1, a first driving mechanism configured to drive the first output shaft 1 to rotate, a second output shaft 2 perpendicular to the first output shaft 1, and a second driving mechanism configured to drive the second output shaft 2 to rotate;
wherein the first driving mechanism includes a motor 30, a driving wheel 31 fixed at an output end of the motor 30, a driven wheel 32 arranged on one side of the driving wheel 31, a driving belt 33 connected between the driving wheel 31 and the driven wheel 32, a first helical gear 34 coaxially fixed below the driven wheel 32, a second helical gear 35 meshed with the first helical gear 34, a driving gear 36 coaxially fixed at a bottom of the second helical gear 35, an output gear 37 meshed with the driving gear 36, a rotating shaft 38 fixed in a middle portion of the output gear 37, and a rotating piece 39 fixed at a bottom of the rotating shaft 38, a middle portion of the first output shaft 1 is rotatably connected to the other end of the rotating piece 39, and a stirring assembly 40 is detachably connected to a bottom of the first output shaft 1;
the first driving mechanism further includes a gear ring 41 fixed on an outer side of the rotating shaft 38 and a planetary gear 42 fixed at a top of the first output shaft 1, the planetary gear 42 being meshed with an inner side of the gear ring 41; and
the second driving mechanism includes a first bevel gear 51 fixed in an upper portion of the rotating shaft 38 and a second bevel gear 52 meshed with the first bevel gear 51, wherein one end of the second output shaft 2 is fixed in a middle portion of the second bevel gear 52, a connecting portion 53 is fixed at the other end of the second output shaft 2, and the other end of the connecting portion 53 is provided with a splicing slot 531 in abutting joint to an accessory driving shaft.

The multifunctional driving mechanism of the present invention uses the first output shaft 1 and the second output shaft 2. The stirring assembly 40 is detachably connected to a bottom of the first output shaft 1 for mixing dough, whipping butter and eggs, and the like. The other end of the second output shaft 2 is provided with the splicing slot 531 in abutting joint to an accessory driving shaft, and an accessory joint can be added to make noodles, mince meat, stuff sausages, slice, shred, dice, grind, juice, and the like, with various functions and convenience in use; moreover, the first output shaft 1 is perpendicular to the second output shaft 2, and the first output shaft and the second output shaft neither conflict with each other nor occupy a very large space during simultaneous working, so that the structure is compact. A first driving mechanism and a second driving mechanism share one motor 30, so that the cost can be lowered and the product size can be reduced while the driving efficiency can be guaranteed.

In the embodiment, the stirring assembly 40 includes a stirring hook, a stirring racket or an egg beating cage. The stirring hook, the stirring racket or the egg beating cage can be respectively used for mixing dough, and whipping butter and eggs.

In the embodiment, the accessory includes a noodle roller, a noodle cutter, a meat mincer, a sausage stuffer, a fruit and vegetable peeling machine, a shredding and slicing machine, a food shredder, a grain grinder, a juicer or a slow juicer. The above accessories can be used for making noodles, mincing meat, stuffing sausages, slicing, shredding, dicing, grinding, juicing, and the like.

In the embodiment, the multifunctional driving mechanism further includes a mounting panel 6 and a gear seat 7 fixed on one side of a bottom of the mounting panel 6, wherein the motor 30 is fixed on the other side below the mounting panel 6, the output end of the motor 30 passes through the mounting panel 6 upwards and rotates synchronously along with the driving wheel 31, a top of the gear seat 7 is provided with an accommodation groove 71 for accommodating the first helical gear 34, the second helical gear 35, the driving gear 36, the output gear 37, and the first bevel gear 51, a bottom of a central shaft of the first helical gear 34 is rotatably connected to a bottom of the accommodation groove 71, a top of the central shaft of the first helical gear 34 passes through the mounting panel 6 upwards and rotates synchronously along with the driven wheel 32, and central shafts of the second helical gear 35 and the driving gear 36 are rotatably connected between the bottom of the mounting panel 6 and the bottom of the accommodation groove 71; a middle portion of the rotating shaft 38 is rotatably connected to a bottom of the gear seat 7, the bottom of the rotating shaft 38 passes through the bottom of the gear seat 7 downwards and stretches out, the gear ring 41 is fixed at the bottom of the gear seat 7, a top of the rotating shaft 38 passes through the mounting panel 6 upwards and stretches out, a position, corresponding to the first bevel gear 51, of the mounting panel 6 is provided with a through hole 61, and a lower portion of the second bevel gear 52 passes through the through hole 61 and is meshed with the first bevel gear 51. The above structure features compact layout and high driving efficiency.

In the embodiment, a protective cover 8 is connected to an outer side of the rotating piece 39 in a sleeved manner. The protective cover 8 is arranged for protecting the gear structure, and can further prevent impurities from falling into the stirring bucket.

In the embodiment, a mounting shell 9 is fixed on one side of a top of the mounting panel 6, a position, corresponding to the connecting portion 53, of the mounting shell 9 is provided with an assembly hole 91, and a mounting portion 92 for mounting an accessory is fixed on an outer side of the assembly hole 91. The mounting portion 92 is arranged for mounting a fixed accessory. A driving shaft of the accessory passes through the assembly hole 91 and is inserted into the splicing slot 531 of the connecting portion 53, and the second output shaft 2 drives the driving shaft of the accessory to rotate, so as to achieve functions of making noodles, mincing meat, stuffing sausages, slicing, shredding, dicing, grinding, juicing, and the like.

In the embodiment, a plurality of L-shaped clamping blocks 93 are arranged in a ring array on an outer side of the mounting portion 92. A plurality of same clamping blocks are arranged at the joint of the accessory in a ring array, but the directions are opposite to the direction of the outer side of the mounting portion 92. The joint of the accessory is abutted and inserted into the mounting portion 92 and is rotated at a certain angle, so as to clamp and fix the accessory.

In the embodiment, the mounting shell 9 is provided with a locking mechanism 94 for locking the accessory. The locking mechanism 94 is arranged for locking the accessory and preventing the accessory from falling off in an operating process.

In the embodiment, the locking mechanism 94 includes a locking bar slidably 941 connected on an outer side of the mounting shell 9, a pulling bar 942 fixed on one side of the locking bar 941, and a compression spring 943 abutted between the mounting shell 9 and the pulling bar 942. Correspondingly, the joint of the accessory is provided with an insertion hole fitting a front end of the locking bar 941. During use, the pulling bar 942 is pressed, the joint of the accessory is abutted and inserted into the mounting portion 92 and is rotated at a certain angle for clamping, then the pulling bar 942 is loosened, the compression spring 943 is reset, and the front end of the locking bar 941 is inserted into the insertion hole of the joint of the accessory, so that the accessory is locked.

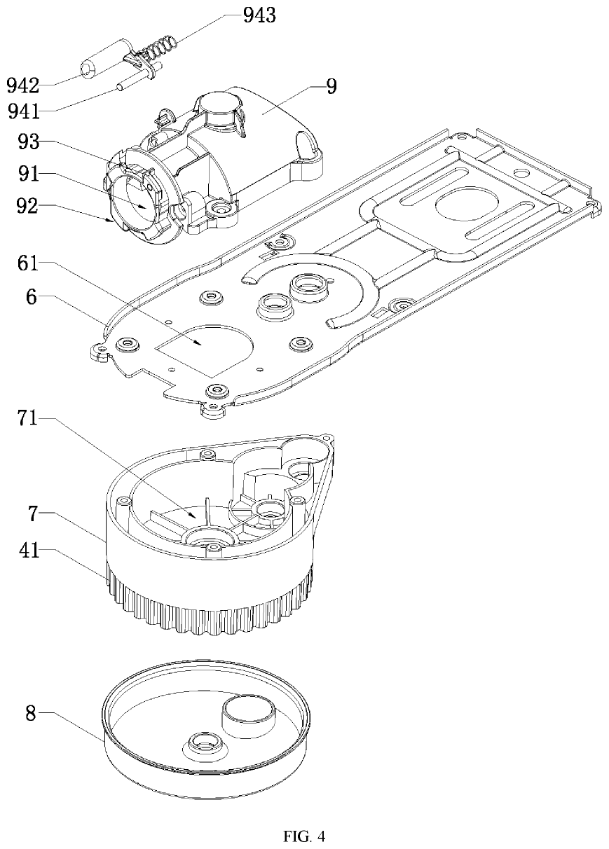

An electrical appliance for kitchen, including the above-mentioned multifunctional driving mechanism. The electrical appliance for kitchen includes a dough mixer (or a dough kneading machine), a bread maker, a fresh milk machine, a stand mixer, an eggbeater, and the like. Optionally, the dough mixer shown in FIG. 4 includes a base 101, a head 102, and a stirring bucket 103, wherein the base 101 includes a base plate 104 and a support 105; a bottom of the stirring bucket 103 is detachably connected to one side of the base plate 104; a bottom of the support 105 is fixed on the other side of the base plate 104; the multifunctional driving mechanism is arranged in the head 102; the stirring assembly 40 is arranged on one side of a bottom of the head 102 and stretches into the stirring bucket 103 downwards; the other end of the bottom of the head 102 is movably connected to an upper end of the support 105, so that the stirring assembly 40 stretches into or moves out of the stirring bucket 103 along with movement of the head 102; the mounting portion 92 for mounting the accessory is located at the other end of the head 102; a front end of the pulling bar 942 stretches out of the other end of the head 102, and a position, corresponding to the assembly hole 91, of the head 102 is provided with a detachable side cover 106. When it is needed to use the accessory, the side cover 106 is opened, then the driving shaft of the accessory passes through the assembly hole 91 and is inserted into the splicing slot 531 of the connecting portion 53, and the accessory is mounted, so that the dough mixer can be used.

The electrical appliance for kitchen provided by the present invention can not only be used for mixing dough, whipping butter and eggs, and the like, but also be added with accessory joints for making noodles, mincing meat, stuffing sausages, slicing, shredding, dicing, grinding, juicing, and the like, with various functions and convenience in use.

The above-mentioned embodiments are preferred embodiments of the present invention. Besides, the present invention can further be implemented in other manners. Any obvious replacement shall within the protection scope of the present invention without departing the conception of the present invention.

What is claimed is:

1. A multifunctional driving mechanism, comprising a first output shaft, a first driving mechanism configured to drive the first output shaft to rotate, a second output shaft perpendicular to the first output shaft, and a second driving mechanism configured to drive the second output shaft to rotate,
wherein the first driving mechanism comprises a motor, a driving wheel fixed at an output end of the motor, a driven wheel arranged on one side of the driving wheel, a driving belt connected between the driving wheel and the driven wheel, a first helical gear coaxially fixed below the driven wheel, a second helical gear meshed with the first helical gear, a driving gear coaxially fixed at a bottom of the second helical gear, an output gear meshed with the driving gear, a rotating shaft fixed in a middle portion of the output gear, and a rotating piece fixed at a bottom of the rotating shaft, a middle portion of the first output shaft is rotatably connected to the other end of the rotating piece, and a stirring assembly is detachably connected to a bottom of the first output shaft;
the first driving mechanism further comprises a gear ring fixed on an outer side of the rotating shaft and a planetary gear fixed at a top of the first output shaft, the planetary gear being meshed with an inner side of the gear ring; and
the second driving mechanism comprises a first bevel gear fixed in an upper portion of the rotating shaft and a second bevel gear meshed with the first bevel gear, wherein one end of the second output shaft is fixed in a middle portion of the second bevel gear, a connecting portion is fixed at the other end of the second output shaft, and the other end of the connecting portion is provided with a splicing slot in abutting joint to an accessory driving shaft.

2. The multifunctional driving mechanism according to claim 1, wherein the stirring assembly comprises a stirring hook, a stirring racket or an egg beating cage.

3. The multifunctional driving mechanism according to claim 1, wherein the accessory comprises a noodle roller, a noodle cutter, a meat mincer, a sausage stuffer, a fruit and vegetable peeling machine, a shredding and slicing machine, a food shredder, a grain grinder, a juicer or a slow juicer.

4. The multifunctional driving mechanism according to claim 1, further comprising a mounting panel and a gear seat fixed on one side of a bottom of the mounting panel, wherein the motor is fixed on the other side below the mounting panel, the output end of the motor passes through the mounting panel upwards and rotates synchronously along with the driving wheel, a top of the gear seat is provided with an accommodation groove for accommodating the first helical gear, the second helical gear, the driving gear, the output gear, and the first bevel gear, a bottom of a central shaft of the first helical gear is rotatably connected to a bottom of the accommodation groove, a top of the central shaft of the first helical gear passes through the mounting panel upwards and rotates synchronously along with the driven wheel, and central shafts of the second helical gear and the driving gear are rotatably connected between the bottom of the mounting panel and the bottom of the accommodation groove; a middle portion of the rotating shaft is rotatably connected to a bottom of the gear seat, the bottom of the rotating shaft passes through the bottom of the gear seat downwards and stretches out, the gear ring is fixed at the bottom of the gear seat, a top of the rotating shaft passes through the mounting panel upwards and stretches out, a position, corresponding to the first bevel gear, of the mounting panel is provided with a through hole, and a lower portion of the second bevel gear passes through the through hole and is meshed with the first bevel gear.

5. The multifunctional driving mechanism according to claim 4, wherein a protective cover is connected to an outer side of the rotating piece in a sleeved manner.

6. The multifunctional driving mechanism according to claim 4, a mounting shell is fixed on one side of a top of the mounting panel, a position, corresponding to the connecting portion, of the mounting shell is provided with an assembly hole, and a mounting portion for mounting an accessory is fixed on an outer side of the assembly hole.

7. The multifunctional driving mechanism according to claim 6, wherein a plurality of L-shaped clamping blocks are arranged in a ring array on an outer side of the mounting portion.

8. The multifunctional driving mechanism according to claim 6, wherein the mounting shell is provided with a locking mechanism for locking the accessory.

9. The multifunctional driving mechanism according to claim 8, wherein the locking mechanism comprises a locking bar slidably connected on an outer side of the mounting shell, a pulling bar fixed on one side of the locking bar, and a compression spring abutted between the mounting shell and the pulling bar.

10. An electrical appliance for kitchen, comprising the multifunctional driving mechanism according to claim 1.
